(19) United States
(12) Patent Application Publication
(10) Pub. No.: US 2022/0108646 A1
(43) Pub. Date: Apr. 7, 2022

(54) ADAPTIVE DISPLAY DATA TRANSFER RATE TO REDUCE POWER CONSUMPTION DURING PARTIAL FRAME COMPOSITION

(71) Applicant: QUALCOMM Incorporated, San Diego, CA (US)

(72) Inventors: Padmanabhan KOMANDURU, V, Hyderabad (IN); Dileep MARCHYA, Hyderabad (IN); Srinivas PULLAKAVI, Kakinada (IN)

(21) Appl. No.: 17/061,962

(22) Filed: Oct. 2, 2020

(51) Int. Cl. G09G 3/20

(52) U.S. Cl. CPC G09G 3/20; G09G 2360/127; G09G 2310/08; G09G 2330/023

(57) ABSTRACT

Methods, systems, and devices for adaptive display data transfer rate to reduce power consumption during partial frame composition are described. The method may include identifying a set of frames for display on a panel of the device, determining a starting line of an updating frame region of the set of frames in relation to a first pixel line of the panel, determining an ending line of the updating frame region of the set of frames in relation to the first pixel line of the panel, reducing a bus bandwidth vote based on the starting line of the updating frame region, or the ending line of the updating frame region, or a number of lines of the updating frame region, or any combination thereof, and transferring the lines of the updating frame region from a display processor unit to a panel memory at the reduced bus bandwidth.

### BACKGROUND

The following relates to adaptive display data transfer rate by a device, including adaptive display data transfer rate to reduce power consumption during partial frame composition.

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

Some devices may display content (e.g., texts, images, videos, etc.) in a format that does not occupy each portion (e.g., all pixels) of a display panel. In some cases, video content being played on a display may occupy a portion of the display (e.g., a middle portion of the display) while other portions remain static (e.g., lines of pixels of the display panel that do not change as the content is played on the display panel). However, though portions of the display are static, the device may continue to process data for every pixel of the display panel, which results in unnecessary power consumption. Accordingly, improved techniques to reduce power consumption based on an adaptive display data transfer rates may be desired.

### SUMMARY

The described techniques relate to improved methods, systems, devices, and apparatuses that support adaptive display data transfer rate to reduce power consumption during partial frame composition. Generally, the described techniques provide for reducing power consumption by identifying a set of frames for display on a panel of a device, determining a starting line of an active region (e.g., updating frame region) of the multiple frames in relation to a first pixel line of the panel, and determining an ending line of the active region of multiple frames in relation to the first pixel line of the panel. The power consumption is reduced by reducing a bus bandwidth vote based on the starting line of the updating frame region, or the ending line of the updating frame region, or a number of lines of the active region, or any combination thereof, and transferring the lines of the updating frame region from a display processor unit to a panel memory at the reduced bus bandwidth.

A method of adaptive display data transfer rate by a device, the method including is described. The method may include identifying a set of frames for display on a panel of the device, determining a starting line of an updating frame region of the set of frames in relation to a first pixel line of the panel, determining an ending line of the updating frame region of the set of frames in relation to the first pixel line of the panel, reducing a bus bandwidth vote based on the starting line of the updating frame region, or the ending line of the updating frame region, or a number of lines of the updating frame region, or any combination thereof, and transferring the lines of the updating frame region from a display processor unit to a panel memory at the reduced bus bandwidth.

An apparatus for adaptive display data transfer rate by a device, the method including is described. The apparatus may include a processor, memory coupled with the processor, and instructions stored in the memory. The instructions may be executable by the processor to cause the apparatus to identify a set of frames for display on a panel of the device, determine a starting line of an updating frame region of the set of frames in relation to a first pixel line of the panel, determine an ending line of the updating frame region of the set of frames in relation to the first pixel line of the panel, reduce a bus bandwidth vote based on the starting line of the updating frame region, or the ending line of the updating frame region, or a number of lines of the updating frame region, or any combination thereof, and transfer the lines of the updating frame region from a display processor unit to a panel memory at the reduced bus bandwidth.

Another apparatus for adaptive display data transfer rate by a device, the method including is described. The apparatus may include means for identifying a set of frames for display on a panel of the device, determining a starting line of an updating frame region of the set of frames in relation to a first pixel line of the panel, determining an ending line of the updating frame region of the set of frames in relation to the first pixel line of the panel, reducing a bus bandwidth vote based on the starting line of the updating frame region, or the ending line of the updating frame region, or a number of lines of the updating frame region, or any combination thereof, and transferring the lines of the updating frame region from a display processor unit to a panel memory at the reduced bus bandwidth.

A non-transitory computer-readable medium storing code for adaptive display data transfer rate by a device, the method including is described. The code may include instructions executable by a processor to identify a set of frames for display on a panel of the device, determine a starting line of an updating frame region of the set of frames in relation to a first pixel line of the panel, determine an ending line of the updating frame region of the set of frames in relation to the first pixel line of the panel, reduce a bus bandwidth vote based on the starting line of the updating frame region, or the ending line of the updating frame region, or a number of lines of the updating frame region, or any combination thereof, and transfer the lines of the updating frame region from a display processor unit to a panel memory at the reduced bus bandwidth.

In some examples of the method, apparatuses, and non-transitory computer-readable medium described herein, reducing the bus bandwidth vote may include operations, features, means, or instructions for reducing the bus bandwidth vote based on a ratio of the number of lines of the updating frame region to a number of lines preceding the ending line of the updating frame region.

Some examples of the method, apparatuses, and non-transitory computer-readable medium described herein may further include operations, features, means, or instructions for reducing a display bandwidth consumption rate based on the ratio of the number of lines of the updating frame region to the number of lines preceding the ending line of the updating frame region.

Some examples of the method, apparatuses, and non-transitory computer-readable medium described herein may further include operations, features, means, or instructions for reducing a clock rate of the display processor unit based on the ratio of the number of lines of the updating frame region to the number of lines preceding the ending line of the updating frame region.

Some examples of the method, apparatuses, and non-transitory computer-readable medium described herein may further include operations, features, means, or instructions for reducing a clock rate of a display serial interface of the device based on the ratio of the number of lines of the updating frame region to the number of lines preceding the ending line of the updating frame region.

Some examples of the method, apparatuses, and non-transitory computer-readable medium described herein may further include operations, features, means, or instructions for reducing the bus bandwidth vote reduces a pixel processing rate of the device in proportion to a static frame region of the set of frames that precedes the starting line of the updating frame region.

In some examples of the method, apparatuses, and non-transitory computer-readable medium described herein, pixels of lines of the static frame region do not change from frame to frame.

In some examples of the method, apparatuses, and non-transitory computer-readable medium described herein, one or more pixels of the lines of the updating frame region change from frame to frame.

In some examples of the method, apparatuses, and non-transitory computer-readable medium described herein, the first pixel line of the panel may be a horizontal line of the panel or a vertical line of the panel.

In some examples of the method, apparatuses, and non-transitory computer-readable medium described herein, the lines of the updating frame region span from the starting line of the updating frame region to the number of lines preceding the ending line of the updating frame region.

### BRIEF DESCRIPTION OF THE DRAWINGS

FIG. 1 illustrates an example of a display processing system of a device for adaptive display data transfer rate by a device that supports adaptive display data transfer rate to reduce power consumption during partial frame composition in accordance with aspects of the present disclosure.

FIG. 2 illustrates an example of a panel that supports adaptive display data transfer rate to reduce power consumption during partial frame composition in accordance with aspects of the present disclosure.

FIGS. 3 and 4 show block diagrams of devices that support adaptive display data transfer rate to reduce power consumption during partial frame composition in accordance with aspects of the present disclosure.

FIG. 5 shows a block diagram of a display manager that supports adaptive display data transfer rate to reduce power consumption during partial frame composition in accordance with aspects of the present disclosure.

FIG. 6 shows a diagram of a system including a device that supports adaptive display data transfer rate to reduce power consumption during partial frame composition in accordance with aspects of the present disclosure.

FIGS. 7 and 8 show flowcharts illustrating methods that support adaptive display data transfer rate to reduce power consumption during partial frame composition in accordance with aspects of the present disclosure.

### DETAILED DESCRIPTION

Graphics devices may include smartphone displays, tablet displays, wearable computer displays, laptop computer displays, etc. The graphics devices may be configured to display frames of content on a display panel. Frames are individual images of a sequence of images that are shown on a display of a graphics device. For example, a sequence of video images may be played at 24 frames per second (or 24 Hz) to create the appearance of motion. A refresh rate may reflect how often a display of a graphics device updates frames being shown on the display.

An exemplary panel may include a resolution of 2880×1440 (e.g., 2,880 vertical lines by 1,440 horizontal lines in a landscape perspective, or 2,880 horizontal lines by 1,440 vertical lines in a portrait perspective). In some cases, some horizontal lines from the panel may be inactive as the video file is being played on the computing device in the portrait perspective or the landscape perspective. In some examples, the video file may be viewed with the computing device in the portrait perspective (e.g., 2,880 horizontal lines). The first 1,035 horizontal lines may be inactive and not include content from the video file being played on the panel (e.g., a first static region of the panel with inactive, non-changing pixels). The next 810 horizontal lines may include content of the video file being played on the panel (e.g., an active region of the panel with active, changing pixels). The last 1,035 horizontal lines may also be inactive and not include content from the video file being played on the panel (e.g., a second static region of the panel with inactive, non-changing pixels).

In some cases, a first portion of the panel memory may be associated with the first static region, a second portion of the panel memory may be associated with the active region, and a third portion of the panel memory may be associated with the second static region. In some cases, the first portion and the third portion of the panel memory associated with the static regions of the panel may be referred to as static memory regions, while the second portion of the panel memory associated with the active region of the panel may be referred to as an updating memory region.

In some systems, the DPU may transfer each line of pixel data (e.g., pixel data of a video file) to the panel memory in a constant time regardless of the time available at the panel to refresh the display from the panel memory. This mismatch in the relatively short time it takes for the DPU to transfer the pixel data to the panel versus the relatively long time it takes for the panel memory to read the first 1,035 horizontal lines (e.g., first static region) and the next 810 horizontal lines (e.g., active region) may result in higher power consumption than desired because the static regions continue to be updated by the panel even though lines of the static regions do not change as the video content is played on the panel, which is a problem for power consumption, especially in higher refresh rate devices.

The present techniques include reducing a pixel processing rate in proportion to a static frame region (e.g., non-updating pixel lines of a frame) of content being displayed on a panel (e.g., a screen of a computing device, etc.). The content may include at least one of an application (e.g., text typing on a text-based application), video playback or video calling or video streaming (e.g., portrait video format with static pixel areas above and below the video content, landscape video format with static pixel areas above and below the video content), photo viewer (e.g., viewing portrait photos with static pixel areas above and below the photo content, viewing landscape photos with static pixel areas above and below the photo content), using multiple windows with an active window and one or more static windows, or any combination thereof. The display bandwidth consumption rate, DPU clock rate, and digital serial interface (DSI) clock rate may be reduced so that each line of the updating region is transferred to the panel at a slower rate. The reduction of clock and bandwidth may depend on the position of the updating frame region on the panel. In some cases, the transfer time by the DPU of the updating frame region may be less than or equal to the read time from memory (e.g., random access memory, main memory, graphics memory, graphics processor memory, etc.) of the updating region plus all lines that precede it in raster scan order. Accordingly, the present techniques reduce power consumption of partial frame composition for graphics devices.

Aspects of the disclosure are initially described in the context of a display processing system of a device and a panel of a display processing system. Aspects of the disclosure are further illustrated by and described with reference to apparatus diagrams, system diagrams, and flowcharts that relate to adaptive display data transfer rate to reduce power consumption during partial frame composition.

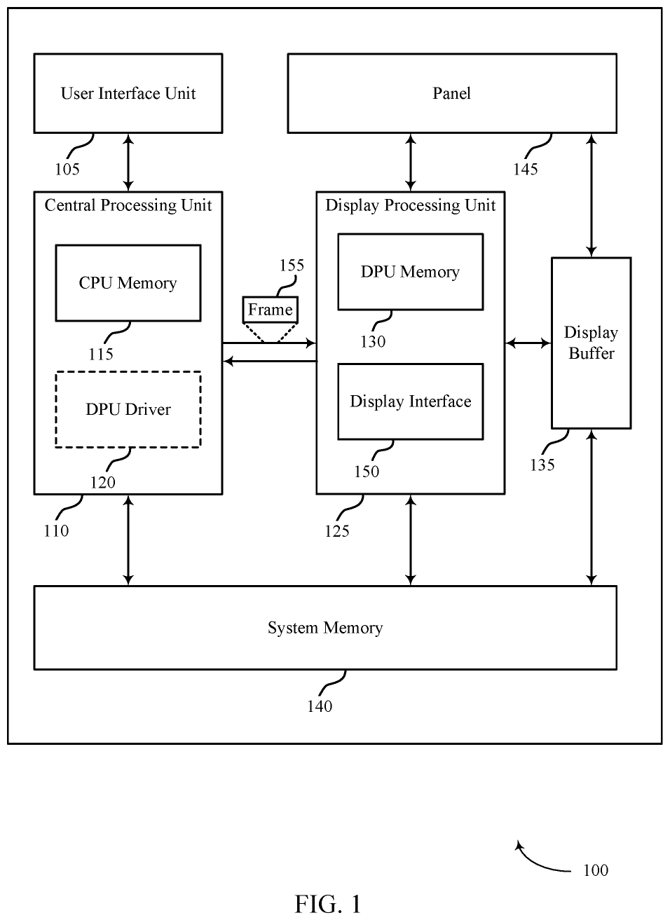

FIG. 1 illustrates an example of a display processing system of a device 100 that supports adaptive display data transfer rate in accordance with aspects of the present disclosure. Device 100 may be an example of a graphics device configured for adaptive display data transfer rate. Examples of device 100 may include, but are not limited to, wireless devices, mobile or cellular telephones, including smartphones, personal digital assistants (PDAs), video gaming consoles that include connect to video displays, mobile video gaming devices, mobile video conferencing units, laptop computers, desktop computers, televisions, tablet computing devices, e-book readers, fixed or mobile media players, and the like.

In the example of FIG. 1, device 100 includes a central processing unit (CPU) 110 having CPU memory 115, a display processing unit (DPU) 125 having DPU memory 130 and display interface 150, a panel 145, a display buffer 135 (e.g., panel memory) storing data associated with graphics shown on panel 145, a user interface unit 105, and a system memory 140. In some examples, system memory 140 may store a DPU driver 120 (illustrated as being included in CPU 110 as described herein) having a compiler, or a DPU program, or a locally-compiled DPU program, or any combination thereof. User interface unit 105, CPU 110, DPU 125, system memory 140, and panel 145 may communicate with each other (e.g., using a system bus). In some cases, DPU 125 may include or be referred to as a display processing unit (DPU).

Examples of CPU 110 include, but are not limited to, a digital signal processor (DSP), general purpose microprocessor, application specific integrated circuit (ASIC), field programmable logic array (FPGA), or other equivalent integrated or discrete logic circuitry. Although CPU 110 and DPU 125 are illustrated as separate units in the example of FIG. 1, in some examples, CPU 110 and DPU 125 may be integrated into a single chip (e.g. a single chip with one or more processor cores of CPU 110 and one or more processor cores of DPU 125). CPU 110 may include one or more processors to execute one or more software applications. Examples of the applications may include operating systems, word processors, spreadsheets, web browsers, e-mail applications, text messaging and instant messaging applications, social media applications, video games, audio and media players, audio and/or video capture, video playback applications, image viewers, video and image editing applications, video calling, video conferencing applications, or other such applications that initiate the generation of image data to be presented via panel 145. As illustrated, CPU 110 may include CPU memory 115. For example, CPU memory 115 may represent on-chip storage or memory used in executing machine or object code. CPU memory 115 may include one or more volatile and/or one or more non-volatile memories or storage devices, such as flash memory, a magnetic data media, an optical storage media, etc. CPU 110 may be configured to read values from or write values to CPU memory 115 more quickly than reading values from or writing values to system memory 140, which may be accessed, e.g., over a system bus.

In some examples, DPU 125 may represent one or more dedicated processors for performing graphical operations. That is, for example, DPU 125 may be a dedicated hardware unit having fixed function and programmable components for processing graphics and executing DPU applications. DPU 125 may also include a DSP, a general purpose microprocessor, an ASIC, an FPGA, or other equivalent integrated or discrete logic circuitry. DPU 125 may be built with a highly-parallel structure that provides more efficient processing of complex graphic-related operations than CPU 110. For example, DPU 125 may include a plurality of processing elements that are configured to operate on multiple vertices or pixels in a parallel manner. The highly parallel nature of DPU 125 may allow DPU 125 to generate graphic images (e.g., graphical user interfaces and two-dimensional or three-dimensional graphics scenes) for panel 145 more quickly than CPU 110.

In some examples, DPU 125 may, in some instances, be integrated into a motherboard of device 100. In other instances, DPU 125 may be present on a graphics card that is installed in a port of or connected to the motherboard of device 100, or may be otherwise incorporated within a peripheral device configured to interoperate with device 100. As illustrated, DPU 125 may include DPU memory 130 and display interface 150. In one example, DPU memory 130 may represent on-chip storage or memory used in executing machine or object code. DPU memory 130 may include one or more volatile and/or one or more non-volatile memories or storage devices, such as flash memory, a magnetic data media, an optical storage media, etc. DPU 125 may be able to read values from or write values to DPU memory 130 more quickly than reading values from or writing values to system memory 140, which may be accessed, e.g., over a system bus. That is, DPU 125 may read data from and write data to DPU memory 130 without using the system bus to access off-chip memory. This operation may allow DPU 125 to operate in a more efficient manner by reducing the need for DPU 125 to read and write data via the system bus, which may experience relatively heavy bus traffic.

In some examples, display interface 150 may be a first interface between the DPU 125 and a component external to DPU 125. In some cases, display interface 150 may include a display serial interface (DSI) that interfaces between the DPU and panel 145. In some cases, display interface 150 may be configured to perform command and frame fetching, state control, and/or register management. In some examples, display interface 150 may include queues for frames for display on panel 145. In some cases, display interface 150 may include direct memory access (DMA) for transfer of frames.

In some cases, panel 145 represents a display unit capable of displaying video, images, text or any other type of data for consumption by a viewer. In some examples, panel 145 may include a liquid-crystal display (LCD), a light emitting diode (LED) display, an organic LED (OLED), an active-matrix OLED (AMOLED), or the like. Display buffer 135 represents a memory or storage device dedicated to storing data for presentation of graphical imagery, such as computer-generated graphics, still images, video frames, or the like for panel 145. Display buffer 135 may represent a graphics buffer that includes a plurality of storage locations. The number of storage locations within display buffer 135 may, in some cases, generally correspond to the number of pixels to be displayed on panel 145. For example, if panel 145 is configured to include 640×480 pixels, display buffer 135 may include 640×480 storage locations storing pixel color and intensity information, such as red, green, and blue pixel values, or other color values. In some examples, display buffer 135 may store the final pixel values for each of the pixels processed by DPU 125. In some examples, panel 145 may retrieve the final pixel values from display buffer 135 and display the final image based on the pixel values stored in display buffer 135.

User interface unit 105 represents a unit with which a user may interact with or otherwise interface to communicate with other units of device 100, such as CPU 110, DPU 125, panel 145, etc. Examples of user interface unit 105 include, but are not limited to, a trackball, a mouse, a keyboard, and other types of input devices. Examples of user interface unit 105 include, but are not limited to, a device driver, operating system, a graphics user interface, graphics settings interface, etc. User interface unit 105 may also be, or include, a touch screen and the touch screen may be incorporated as part of panel 145.

System memory 140 may comprise one or more computer-readable storage media. Examples of system memory 140 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 140 may store program modules and/or instructions that are accessible for execution by CPU 110 (e.g., program modules and/or instructions configured for adaptive display data transfer rate). Additionally, system memory 140 may store user applications and application surface data associated with the applications. System memory 140 may in some cases store information for use by and/or information generated by other components of device 100. For example, system memory 140 may act as a device memory for DPU 125 and may store data to be operated on by DPU 125 (e.g., in a direct rendering operation) as well as data resulting from operations performed by DPU 125.

In some examples, system memory 140 may include instructions that cause CPU 110 or DPU 125 to perform the functions ascribed to CPU 110 or DPU 125 in aspects of the present disclosure. System memory 140 may, in some examples, be considered as a non-transitory storage medium. The term “non-transitory” should not be interpreted to mean that system memory 140 is non-movable. As one example, system memory 140 may be removed from device 100 and moved to another device. As another example, a system memory substantially similar to system memory 140 may be inserted into device 100. In some examples, a non-transitory storage medium may store data that can, over time, change (e.g., in RAM).

System memory 140 may store a DPU driver 120. In some examples, system memory 140 may store a compiler, or a DPU program, or a locally-compiled DPU program, or any combination thereof. The DPU driver 120 may represent a computer program or executable code that provides an interface to access DPU 125. CPU 110 may execute the DPU driver 120 or portions thereof to interface with DPU 125. DPU driver 120 may be accessible to programs or other executables executed by CPU 110, including the DPU program stored in system memory 140. Thus, when one of the software applications executing on CPU 110 requests graphics processing, CPU 110 may provide graphics commands and graphics data to DPU 125 for showing graphics on panel 145 (e.g., via DPU driver 120).

The DPU program stored in system memory 140 may invoke or otherwise include one or more functions provided by DPU driver 120. CPU 110 generally executes the program in which the DPU program is embedded and, upon encountering the DPU program, passes the DPU program to DPU driver 120. CPU 110 may execute DPU driver 120 in this context to process the DPU program. That is, for example, DPU driver 120 may process the DPU program by compiling the DPU program into object or machine code executable by DPU 125. This object code may be referred to as a locally-compiled DPU program. In some examples, a compiler associated with DPU driver 120 may operate in real-time or near-real-time to compile the DPU program during the execution of the program in which the DPU program is embedded.

In some examples, CPU 110 may receive, generate, and/or process, one or more frames for display on panel 145. In the illustrated example, CPU 110 may generate at least frame 155. In some examples, CPU 110 may send frame 155 to DPU 125. In some cases, DPU 125 may perform graphical processing on frame 155. In some examples, frame 155 may be displayed on panel 145 based on a current display resolution and current refresh rate for panel 145. In some examples, a combination of increasing display resolution and refresh rate may increase power consumption and put significant stress on memory bandwidth of device 100.

In some examples, device 100 may be configured to display frames of content on panel 145. Frames may include individual images of a sequence of images that are shown on panel 145. For example, a sequence of video images may be played at 24 frames per second (or 24 Hz) to create the appearance of motion. A refresh rate may reflect how often device 100 updates frames being shown on panel 145. In some cases, content shown on panel 145 may include active regions (areas of panel 145 that include changing pixel values) and static regions (areas of panel 145 that do not change as the content is shown on panel 145).

In some examples, device 100 may include a video file (a downloaded video file, a stored video file, a streaming video file, etc.) that includes multiple frames at some given resolution (e.g., 1920×1080 at 30 frames per second, etc.). The DPU 125 may process a frame of the video file and display the processed frame on panel 145. For each frame of the video file, the DPU 125 may compose pixel data from the given frame and transfer the pixel data to the panel 145 over display interface 150 (e.g., display serial interface (DSI) between DPU 125 and panel 145). In some cases, panel 145 may include panel memory (e.g., display buffer 135, display driver integrated circuit (DDIC) memory, etc.).

In some examples, device 100 (e.g., one or more components of device 100, CPU 110, DPU 125, system memory 140, display buffer 135, panel 145, etc.) may implement an adaptive display data transfer rate to reduce power consumption during partial frame composition. In some examples, device 100 may reduce a pixel processing rate in proportion to a static frame region (e.g., non-updating pixel lines of a frame) of content being displayed on a panel (e.g., a screen of a computing device, etc.).

In some examples, device 100 may identify one or more frames (e.g., frame 155) for display on panel 145. In some examples, device 100 may identify an active region of panel 145 (e.g., updating frame region). In some examples, device 100 may identify a static region (e.g., static frame region). In some examples, device 100 may determine a starting line (e.g., starting line of pixels) of an updating frame region of the frames in relation to a first pixel line of the panel 145. In some cases, the first pixel line may be a line of pixels running across the top of panel 145 when panel 145 is held upright (e.g., in portrait view), or may be a line of pixels running across the top of panel 145 when panel 145 is held sideways (e.g., in landscape view). In some examples, device 100 may determine an ending line of the updating frame region of the frames in relation to the first pixel line of the panel 145.

In some examples, device 100 may reduce a bus bandwidth vote based at least in part on the starting line of the updating frame region, or the ending line of the updating frame region, or a number of lines of the updating frame region (e.g., lines between the starting line of the updating frame region and the ending line of the updating frame region, including the starting line or the ending line or both). In some examples, device 100 may transfer the lines of the updating frame region from a display processor unit (e.g., CPU 110, DPU 125, etc.) to a panel memory (e.g., display buffer 135) at the reduced bus bandwidth.

Accordingly, device 100 may be configured to dynamically adjust a display data transfer rate to reduce power consumption and reduce memory bandwidth usage during partial frame composition without affecting the user experience (e.g., without affecting performance for content within the updating frame region).

The techniques described herein may provide improvements in power consumption and improved device battery life. Also, the techniques described herein may provide benefits and enhancements to the operation of the devices 105. For example, by implementing adaptive display data transfer rate during partial frame composition, the operational characteristics, such as power consumption, processor utilization, and memory usage of the devices 105 may be reduced.

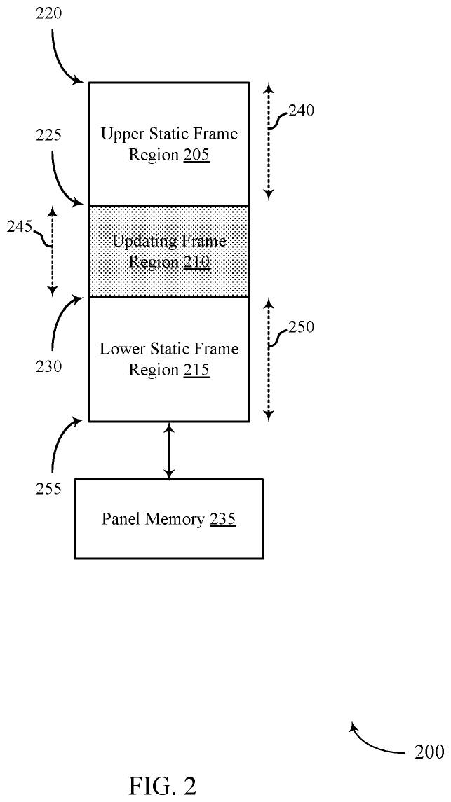

FIG. 2 illustrates an example of a panel 200 that supports adaptive display data transfer rate to reduce power consumption during partial frame composition in accordance with aspects of the present disclosure. In some examples, panel 200 may implement aspects of the display processing system of device 100. Panel 200 may be an example of panel 145 of FIG. 1.

In some examples, panel 200 may include an exemplary resolution of 2880×1440 (e.g., 2,880 horizontal lines by 1,440 vertical lines in the portrait perspective as shown, or 2,880 vertical lines by 1,440 horizontal lines in a landscape perspective). When displaying content of some format, panel 200 may include active or updating regions (e.g., lines of pixels of panel 200 that change as content is displayed) and inactive or static regions (e.g., lines of pixels of panel 20 that do not change or do not include content as the content is displayed on panel 200).

In the illustrated example, panel 200 may include upper static frame region 205 (e.g., an inactive region, lines of pixels where no content is being displayed or where content being displayed does not change), updating frame region 210 (e.g., an active region, lines of pixels showing active content that changes, lines of pixels that are updated with changing pixel values), and lower static frame region 215 (e.g., an inactive region, lines of pixels where no content is being displayed or where content being displayed does not change).

In some examples, a device (e.g., device 100) may include a video file that includes multiple frames at some given resolution (e.g., 1920×1080 at 30 frames per second, etc.). A DPU (e.g., DPU 125) may process a frame of the video file and display the processed frame on panel 200. For each frame of the video file, the DPU may compose pixel data from the given frame and transfer the pixel data to the panel 200 over display interface (e.g., display interface 150). In some cases, panel 200 may include panel memory 235 (e.g., display buffer 135). In some cases, panel memory 235 may include display driver integrated circuit (DDIC) memory.

In some cases, some pixel lines from panel 200 (e.g., pixels lines of upper static frame region 205, pixels lines of lower static frame region 215) may be inactive as the video file is being displayed on panel 200 in the portrait perspective or the landscape perspective. In some examples, the video file may be viewed with panel 200 in the portrait perspective (e.g., 2,880 horizontal lines), where pixel line 220 is the first line (e.g., the top of panel 200 in the illustrated portrait view) of the 2,880 horizontal lines, pixel line 225 is the first line of updating frame region 210, pixel line 230 is the last line of updating frame region 210, pixel line 255 is the last line (e.g., the bottom of panel 200 in the illustrated portrait view) of the 2,880 horizontal lines.

In the illustrated example, the upper static frame region 205 may include non-updating pixel lines 240 (e.g., the first 1,035 horizontal lines of the 2,880 horizontal lines) from pixel line 220 to pixel line 225, which may be non-changing and/or not include content from the video file being played on panel 200 (e.g., a first static region of panel 200 with inactive, non-changing lines of pixels). The updating frame region 210 may include updating pixel lines 245 (e.g., the next 810 horizontal lines from pixel line 225 to pixel line 230), which may include content of the video file being played on panel 200 (e.g., an active region of the panel 200 with active, changing pixels). The lower static frame region 215 may include non-updating pixel lines 250 (e.g., the last 1,035 horizontal lines), which may be inactive and/or not include content from the video file being played on panel 200 (e.g., a second static region of panel 200 with inactive, non-changing pixels).

In some examples, a first portion of the panel memory 235 may be associated with upper static frame region 205 (e.g., store pixel data for pixels lines of upper static frame region 205), a second portion of the panel memory 235 may be associated with the updating frame region 210 (e.g., store pixel data for pixels lines of updating frame region 210), and a third portion of the panel memory 235 may be associated with the lower static frame region 215 (e.g., store pixel data for pixels lines of lower static frame region 215). In some cases, the first portion and the third portion of the panel memory 235 associated with the static regions of panel 200 may be referred to as static memory regions, while the second portion of the panel memory 235 associated with updating frame region 210 of panel 200 may be referred to as an updating memory region.

In some examples, a DPU (e.g., DPU 125) may transfer each line of pixel data (e.g., pixel values, pixel data of the video file) to the panel memory 235 in a constant time regardless of the time available at panel 200 to refresh panel 200 from the panel memory 235. This mismatch in the time (e.g., relatively short time) it takes for DPU 125 to transfer the pixel data to panel 200 versus the time (e.g., relatively long time) it takes for the panel memory 235 to read non-updating pixel lines 240 of upper static frame region 205 (e.g., the first 1,035 horizontal lines, first static region) and updating pixel lines 245 of updating frame region 210 (e.g., the next 810 horizontal lines, active region) may result in relatively high power consumption due to the pixels of non-updating pixel lines 240 and non-updating pixel lines 250 of the static regions (e.g., upper static frame region 205 and/or lower static frame region 215) continuing to be updated by panel 200 even though the pixel lines of these static regions do not change as the video content is played on panel 200, resulting in significant power consumption, especially in higher refresh rate devices.

In some examples, a device (e.g., device 100, device 205) may reduce a pixel processing rate in proportion to the number of non-updating pixel lines 240 of upper static frame region 205 that precede the updating pixel lines 245 of updating frame region 210 (e.g., from pixel line 225 inclusive to pixel line 230 inclusive). In some examples, the device may reduce a display bandwidth consumption rate of the device, or a clock rate of a DPU of the device, or a clock rate of display interface of the DPU (e.g., display serial interface), or any combination thereof such that each line of updating pixel lines 245 is transferred to the panel memory 235 at a slower rate while maintaining a user experience (e.g., while maintaining a tear-free display, maintaining a read/write synchronization, etc.). In some cases, the device may reduce clock and bandwidth votes. In some cases, the reduction of clock and bandwidth votes may depend on the position of the updating pixel lines 245 on panel 200.

In some examples, the device may adjust the clock and bandwidth votes so that the transfer time of updating pixel lines 245 (e.g., elapsed time to transfer active pixel data from DPU to panel memory 235) is less than or equal to a read time of non-updating pixel lines 240 and updating pixel lines 245 (e.g., elapsed time to read the active pixel data and preceding inactive pixel data from panel memory 235). Where W=updating pixel lines 245, and R=non-updating pixel lines 240+updating pixel lines 245, current bandwidth and clock votes may be adjusted (e.g., reduced, increased) by a factor of (R/W). In some cases, a new bandwidth and clock vote=previous bandwidth and clock vote*(W/R). In some examples, an increase in R elongates the time to update W lines from DPU. In some examples, the bandwidth and clock vote reduction may increase as the updating frame region 210 is shifted towards the bottom of panel 200 (shifted downward into lower static frame region 215, towards or up to pixel line 255 of the non-updating pixel lines 250).

In some examples, the device of panel 200 may identify frames for display on panel 200. In some cases, the device may determine pixel line 225 (e.g., starting pixel line of updating frame region 210) for the multiple frames in relation to pixel line 220 (e.g., the first pixel line of panel 200). In some cases, the device may determine pixel line 230 (e.g., ending pixel line of updating frame region 210) of the multiple frames in relation to pixel line 220. In some examples, the device may reduce a bus bandwidth vote based at least in part on the determined pixel line 225, or the determined pixel line 230, or a number of lines in updating pixel lines 245, or any combination thereof. In some examples, the device may transfer the lines of updating pixel lines 245 from a DPU of the device to panel memory 235 at the reduced bus bandwidth.

In some examples, the device may reduce the bus bandwidth vote, or a display bandwidth consumption rate (e.g., a rate at which panel memory 235 allows data from the DPU to be received by panel memory 235, or a rate at which panel 200 allows data from panel memory 235 to be received by panel 200, or both), or a clock rate of a DPU of the device, or a clock rate of a display serial interface (e.g., display interface 150) of the device, or any combination thereof, based at least in part on a ratio of the number of lines of the updating frame region 210 (e.g., updating pixel lines 245) to a number of lines preceding the ending line of the updating frame region 210 (e.g., updating pixel lines 245 combined with non-updating pixel lines 240, ratio of R/W, or ratio W/R).

In some examples, reducing the bus bandwidth vote may reduce a pixel processing rate of the device in proportion to the upper static frame region 205 that precedes the starting line (e.g., pixel line 225) of the updating frame region 210. In some examples, pixels of lines of the upper static frame region 205 do not change from frame to frame. In some examples, one or more pixels of the pixel lines of the updating frame region 210 change from frame to frame. In some examples, the pixel lines of the updating frame region 210 span from pixel line 225 to pixel line 230.

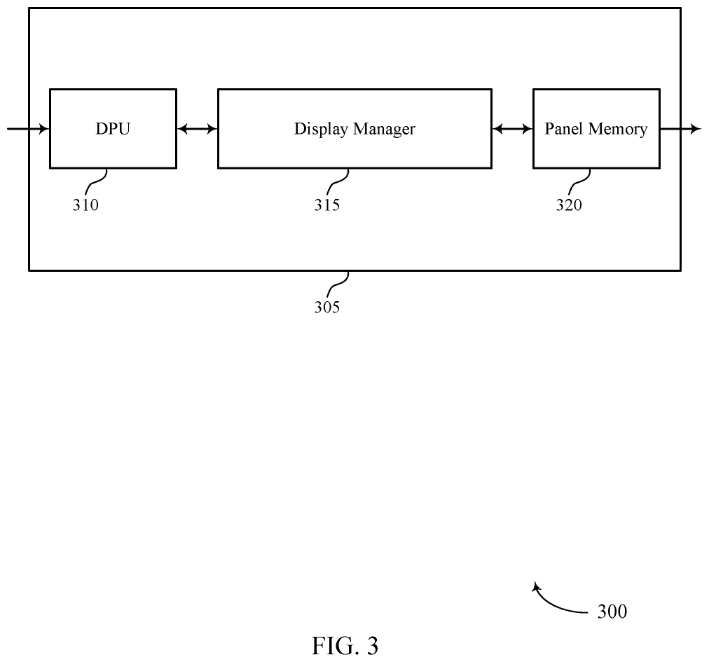

FIG. 3 shows a block diagram 300 of a device 305 that supports adaptive display data transfer rate to reduce power consumption during partial frame composition in accordance with aspects of the present disclosure. The device 305 may be an example of aspects of a device as described herein. The device 305 may include a display processing unit (DPU) 310, a display manager 315, and a panel memory 320. The device 305 may also include a processor. Each of these components may be in communication with one another (e.g., via one or more buses).

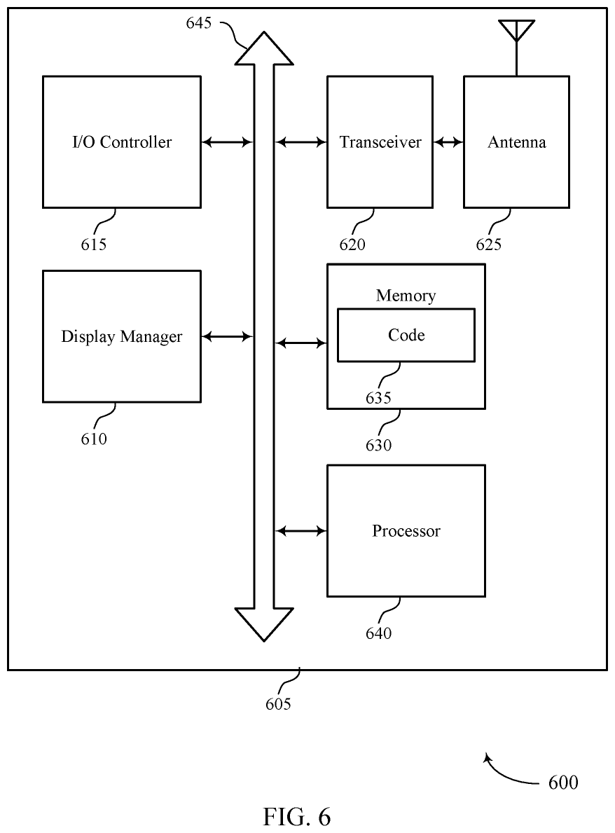

In some examples, DPU 310 may process one or more frames for display on a panel (e.g., panel 145). In some examples, DPU 310 may or at least some of its sub-components may be implemented in hardware, software executed by DPU 310, firmware, or any combination thereof. When implemented in software executed by DPU 310, the functions of the DPU 310 and/or at least some of its various sub-components may be executed by or in conjunction with display manager 315, which may include at least one of a general-purpose processor, a DSP, an ASIC, an FPGA or other programmable logic device, discrete gate or transistor logic, discrete hardware components, or any combination thereof designed to perform the functions described in the present disclosure. In some examples, DPU 310 may be an example of DPU 125 of FIG. 1, DPU 310 of FIG. 3, or processor 640 of FIG. 6.

The display manager 315 may identify a set of frames for display on a panel of the device, determine a starting line of an updating frame region of the set of frames in relation to a first pixel line of the panel, determine an ending line of the updating frame region of the set of frames in relation to the first pixel line of the panel, reduce a bus bandwidth vote based on the starting line of the updating frame region, or the ending line of the updating frame region, or a number of lines of the updating frame region, or any combination thereof, and transfer the lines of the updating frame region from a display processor unit to a panel memory at the reduced bus bandwidth. The display manager 315 may be an example of aspects of the display manager 610 described herein.

The display manager 315, or its sub-components, may be implemented in hardware, code (e.g., software or firmware) executed by a processor, or any combination thereof. If implemented in code executed by a processor, the functions of the display manager 315, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The display manager 315, or its sub-components, may be physically located at various positions, including being distributed such that portions of functions are implemented at different physical locations by one or more physical components. In some examples, the display manager 315, or its sub-components, may be a separate and distinct component in accordance with various aspects of the present disclosure. In some examples, the display manager 315, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

In some examples, panel memory 320 may store information (e.g., one or more frames, pixel data, etc.) generated by other components of device 305 such as DPU 310, display manager 315, etc. In some examples, panel memory 320 may store one or more frames for display on a panel (e.g., panel 145). In some examples, the panel memory 320 may be collocated with one or more processors in a computing device (e.g., device 305). In some cases, the panel memory 320 may be an example of aspects of the memory 630 described with reference to FIG. 6. In some cases, panel memory 320 may include one or more computer-readable storage media. Examples of panel memory 320 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., display manager 315).

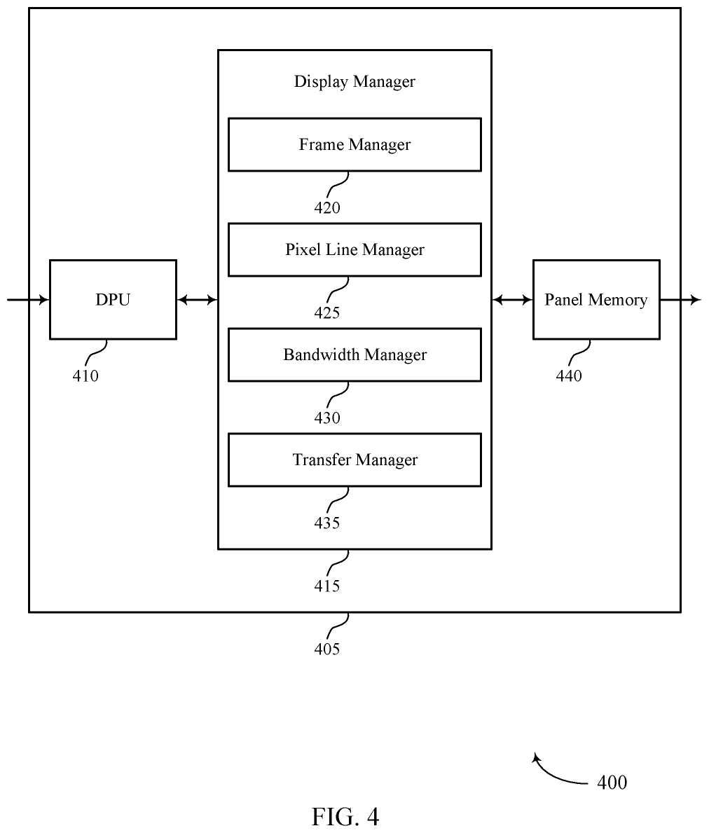

FIG. 4 shows a block diagram 400 of a device 405 that supports adaptive display data transfer rate to reduce power consumption during partial frame composition in accordance with aspects of the present disclosure. The device 405 may be an example of aspects of a device 305 or a device 100 as described herein. The device 405 may include a DPU 410, a display manager 415, and a panel memory 440. The device 405 may also include a processor. Each of these components may be in communication with one another (e.g., via one or more buses).

In some examples, DPU 410 may receive, transmit, process, or store frames, information, data, or signals generated by other components of the device 405. In some examples, the DPU 410 may be collocated with one or more processors in a computing device (e.g., device 405). In some cases, DPU 410 may be an example of DPU 125 of FIG. 1, DPU 310 of FIG. 3, or processor 640 of FIG. 6.

The display manager 415 may be an example of aspects of the display manager 315 as described herein. The display manager 415 may include a frame manager 420, a pixel line manager 425, a bandwidth manager 430, and a transfer manager 435. The display manager 415 may be an example of aspects of the display manager 610 described herein.

The frame manager 420 may identify a set of frames for display on a panel of the device 405. The pixel line manager 425 may determine a starting line of an updating frame region of the set of frames in relation to a first pixel line of the panel and determine an ending line of the updating frame region of the set of frames in relation to the first pixel line of the panel.

The bandwidth manager 430 may reduce a bus bandwidth vote based on the starting line of the updating frame region, or the ending line of the updating frame region, or a number of lines of the updating frame region, or any combination thereof. The transfer manager 435 may transfer the lines of the updating frame region from a display processor unit to a panel memory at the reduced bus bandwidth.

The panel memory 440 may store information (e.g., one or more frames, pixel data, etc.) generated by other components of device 405 such as display manager 415. For example, panel memory 440 may store one or more frames for display on a panel (e.g., panel 145). In some examples, the panel memory 440 may be collocated with one or more processors in a computing device (e.g., device 405). In some cases, the panel memory 440 may be an example of aspects of the memory 630 described with reference to FIG. 6.

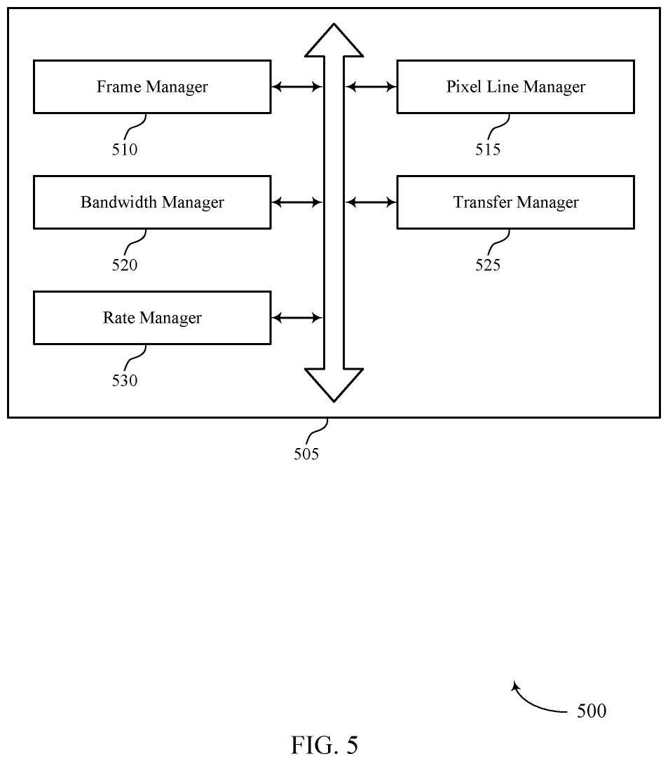

FIG. 5 shows a block diagram 500 of a display manager 505 that supports adaptive display data transfer rate to reduce power consumption during partial frame composition in accordance with aspects of the present disclosure. The display manager 505 may be an example of aspects of a display manager 315, a display manager 415, or a display manager 610 described herein. The display manager 505 may include a frame manager 510, a pixel line manager 515, a bandwidth manager 520, a transfer manager 525, and a rate manager 530. Each of these modules may communicate, directly or indirectly, with one another (e.g., via one or more buses).

The frame manager 510 may identify a set of frames for display on a panel of the device. The pixel line manager 515 may determine a starting line of an updating frame region of the set of frames in relation to a first pixel line of the panel. In some examples, the pixel line manager 515 may determine an ending line of the updating frame region of the set of frames in relation to the first pixel line of the panel. The bandwidth manager 520 may reduce a bus bandwidth vote based on the starting line of the updating frame region, or the ending line of the updating frame region, or a number of lines of the updating frame region, or any combination thereof. The transfer manager 525 may transfer the lines of the updating frame region from a display processor unit to a panel memory at the reduced bus bandwidth.

In some examples, the bandwidth manager 520 may reduce the bus bandwidth vote based on a ratio of the number of lines of the updating frame region to a number of lines preceding the ending line of the updating frame region. In some examples, the bandwidth manager 520 may reduce a pixel processing rate of the device in proportion to a static frame region of the set of frames that precedes the starting line of the updating frame region.

The rate manager 530 may reduce a display bandwidth consumption rate based on the ratio of the number of lines of the updating frame region to the number of lines preceding the ending line of the updating frame region. In some examples, the rate manager 530 may reduce a clock rate of the display processor unit based on the ratio of the number of lines of the updating frame region to the number of lines preceding the ending line of the updating frame region. In some examples, the rate manager 530 may reduce a clock rate of a display serial interface of the device based on the ratio of the number of lines of the updating frame region to the number of lines preceding the ending line of the updating frame region.

In some examples, pixels of lines of the static frame region do not change from frame to frame. In some cases, one or more pixels of the lines of the updating frame region change from frame to frame. In some cases, the first pixel line of the panel may be a horizontal line of the panel or a vertical line of the panel. In some cases, the lines of the updating frame region span from the starting line of the updating frame region to the number of lines preceding the ending line of the updating frame region.

FIG. 6 shows a diagram of a system 600 including a device 605 that supports adaptive display data transfer rate to reduce power consumption during partial frame composition in accordance with aspects of the present disclosure. The device 605 may be an example of or include the components of device 305, device 405, or a device as described herein. The device 605 may include components for bi-directional voice and data communications including components for transmitting and receiving communications, including a display manager 610, an I/O controller 615, a transceiver 620, an antenna 625, memory 630, a processor 640, and a coding manager 650. These components may be in electronic communication via one or more buses (e.g., bus 645).

The display manager 610 may identify a set of frames for display on a panel of the device, determine a starting line of an updating frame region of the set of frames in relation to a first pixel line of the panel, determine an ending line of the updating frame region of the set of frames in relation to the first pixel line of the panel, reduce a bus bandwidth vote based on the starting line of the updating frame region, or the ending line of the updating frame region, or a number of lines of the updating frame region, or any combination thereof, and transfer the lines of the updating frame region from a display processor unit to a panel memory at the reduced bus bandwidth.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The transceiver 620 may communicate bi-directionally, via one or more antennas, wired, or wireless links as described herein. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas.

In some cases, the wireless device may include a single antenna 625. However, in some cases the device may have more than one antenna 625, which may be capable of concurrently transmitting or receiving multiple wireless transmissions.

The memory 630 may include RAM and ROM. The memory 630 may store computer-readable, computer-executable code 635 including instructions that, when executed, cause the processor to perform various functions described herein. In some cases, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting adaptive display data transfer rate to reduce power consumption during partial frame composition).

The code 635 may include instructions to implement aspects of the present disclosure, including instructions to support adaptive display data transfer rate by a device. The code 635 may be stored in a non-transitory computer-readable medium such as system memory or other type of memory. In some cases, the code 635 may not be directly executable by the processor 640 but may cause a computer (e.g., when compiled and executed) to perform functions described herein.

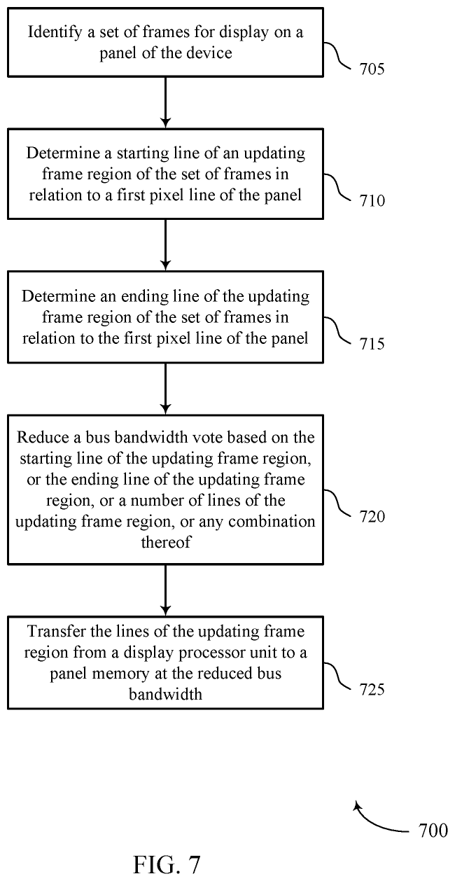

FIG. 7 shows a flowchart illustrating a method 700 that supports adaptive display data transfer rate to reduce power consumption during partial frame composition in accordance with aspects of the present disclosure. The operations of method 700 may be implemented by a device or its components as described herein. For example, the operations of method 700 may be performed by a display manager as described with reference to FIGS. 3 through 6. In some examples, a device may execute a set of instructions to control the functional elements of the device to perform the functions described herein. Additionally or alternatively, a device may perform aspects of the functions described herein using special-purpose hardware.

At 705, the device may identify a set of frames for display on a panel of the device. The operations of 705 may be performed according to the methods described herein. In some examples, aspects of the operations of 705 may be performed by a frame manager as described with reference to FIGS. 3 through 6.

At 710, the device may determine a starting line of an updating frame region of the set of frames in relation to a first pixel line of the panel. The operations of 710 may be performed according to the methods described herein. In some examples, aspects of the operations of 710 may be performed by a pixel line manager as described with reference to FIGS. 3 through 6.

At 715, the device may determine an ending line of the updating frame region of the set of frames in relation to the first pixel line of the panel. The operations of 715 may be performed according to the methods described herein. In some examples, aspects of the operations of 715 may be performed by a pixel line manager as described with reference to FIGS. 3 through 6.

At 720, the device may reduce a bus bandwidth vote based on the starting line of the updating frame region, or the ending line of the updating frame region, or a number of lines of the updating frame region, or any combination thereof. The operations of 720 may be performed according to the methods described herein. In some examples, aspects of the operations of 720 may be performed by a bandwidth manager as described with reference to FIGS. 3 through 6.

At 725, the device may transfer the lines of the updating frame region from a display processor unit to a panel memory at the reduced bus bandwidth. The operations of 725 may be performed according to the methods described herein. In some examples, aspects of the operations of 725 may be performed by a transfer manager as described with reference to FIGS. 3 through 6.

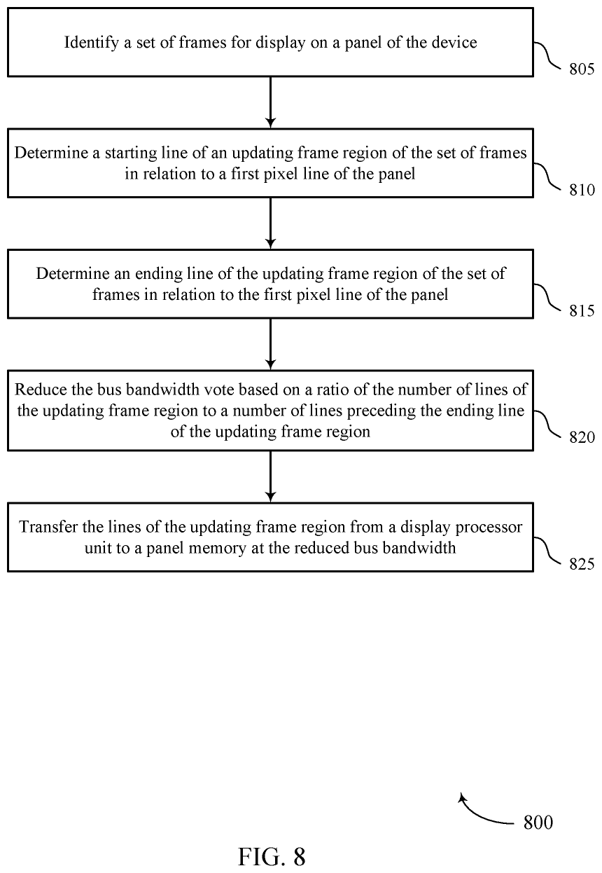

FIG. 8 shows a flowchart illustrating a method 800 that supports adaptive display data transfer rate to reduce power consumption during partial frame composition in accordance with aspects of the present disclosure. The operations of method 800 may be implemented by a device or its components as described herein. For example, the operations of method 800 may be performed by a display manager as described with reference to FIGS. 3 through 6. In some examples, a device may execute a set of instructions to control the functional elements of the device to perform the functions described herein. Additionally or alternatively, a device may perform aspects of the functions described herein using special-purpose hardware.

At 805, the device may identify a set of frames for display on a panel of the device. The operations of 805 may be performed according to the methods described herein. In some examples, aspects of the operations of 805 may be performed by a frame manager as described with reference to FIGS. 3 through 6.

At 810, the device may determine a starting line of an updating frame region of the set of frames in relation to a first pixel line of the panel. The operations of 810 may be performed according to the methods described herein. In some examples, aspects of the operations of 810 may be performed by a pixel line manager as described with reference to FIGS. 3 through 6.

At 815, the device may determine an ending line of the updating frame region of the set of frames in relation to the first pixel line of the panel. The operations of 815 may be performed according to the methods described herein. In some examples, aspects of the operations of 815 may be performed by a pixel line manager as described with reference to FIGS. 3 through 6.

At 820, the device may reduce the bus bandwidth vote based on a ratio of the number of lines of the updating frame region to a number of lines preceding the ending line of the updating frame region. The operations of 820 may be performed according to the methods described herein. In some examples, aspects of the operations of 820 may be performed by a bandwidth manager as described with reference to FIGS. 3 through 6.

At 825, the device may transfer the lines of the updating frame region from a display processor unit to a panel memory at the reduced bus bandwidth. The operations of 825 may be performed according to the methods described herein. In some examples, aspects of the operations of 825 may be performed by a transfer manager as described with reference to FIGS. 3 through 6.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for adaptive display data transfer rate by a device, the method comprising:
identifying a plurality of frames for display on a panel of the device;
determining a starting line of an updating frame region of the plurality of frames in relation to a first pixel line of the panel;
determining an ending line of the updating frame region of the plurality of frames in relation to the first pixel line of the panel, wherein the panel comprises the updating frame region and a static frame region that precedes the starting line of the updating frame region, or is after the ending line of the updating frame region, or both, wherein the static frame region is configured for displaying content on the panel of the device;
reducing a bus bandwidth vote based at least in part on the starting line of the updating frame region, or the ending line of the updating frame region, or a number of lines of the updating frame region, or any combination thereof; and
transferring the lines of the updating frame region from a display processor unit to a panel memory at the reduced bus bandwidth.

2. The method of claim 1, wherein reducing the bus bandwidth vote comprises:
reducing the bus bandwidth vote based at least in part on a ratio of the number of lines of the updating frame region to a number of lines preceding the ending line of the updating frame region.

3. The method of claim 2, further comprising:
reducing a display bandwidth consumption rate based at least in part on the ratio of the number of lines of the updating frame region to the number of lines preceding the ending line of the updating frame region.

4. The method of claim 2, further comprising:
reducing a clock rate of the display processor unit based at least in part on the ratio of the number of lines of the updating frame region to the number of lines preceding the ending line of the updating frame region.

5. The method of claim 2, further comprising:
reducing a clock rate of a display serial interface of the device based at least in part on the ratio of the number of lines of the updating frame region to the number of lines preceding the ending line of the updating frame region.

6. The method of claim 1, wherein:
reducing the bus bandwidth vote reduces a pixel processing rate of the device in proportion to the static frame region of the plurality of frames that precedes the starting line of the updating frame region.

7. The method of claim 6, wherein:
pixels of lines of the static frame region do not change from frame to frame.

8. The method of claim 1, wherein one or more pixels of the lines of the updating frame region change from frame to frame.

9. The method of claim 1, wherein the first pixel line of the panel is a horizontal line of the panel or a vertical line of the panel.

10. The method of claim 1, wherein the lines of the updating frame region span from the starting line of the updating frame region to the number of lines preceding the ending line of the updating frame region.

11. An apparatus for adaptive display data transfer rate by a device, the apparatus comprising:
a processor,
memory coupled with the processor; and
instructions stored in the memory and executable by the processor to cause the apparatus to:
identify a plurality of frames for display on a panel of the device;
determine a starting line of an updating frame region of the plurality of frames in relation to a first pixel line of the panel;
determine an ending line of the updating frame region of the plurality of frames in relation to the first pixel line of the panel, wherein the panel comprises the updating frame region and a static frame region that precedes the starting line of the updating frame region, or is after the ending line of the updating frame region, or both, the updating frame region and the static frame region being configured for displaying content on the panel of the device;
reduce a bus bandwidth vote based at least in part on the starting line of the updating frame region, or the ending line of the updating frame region, or a number of lines of the updating frame region, or any combination thereof; and
transfer the lines of the updating frame region from a display processor unit to a panel memory at the reduced bus bandwidth.

12. The apparatus of claim 11, wherein the instructions to reduce the bus bandwidth vote are executable by the processor to cause the apparatus to:
reduce the bus bandwidth vote based at least in part on a ratio of the number of lines of the updating frame region to a number of lines preceding the ending line of the updating frame region.

13. The apparatus of claim 12, wherein the instructions are further executable by the processor to cause the apparatus to:
reduce a display bandwidth consumption rate based at least in part on the ratio of the number of lines of the updating frame region to the number of lines preceding the ending line of the updating frame region.

14. The apparatus of claim 12, wherein the instructions are further executable by the processor to cause the apparatus to:
reduce a clock rate of the display processor unit based at least in part on the ratio of the number of lines of the updating frame region to the number of lines preceding the ending line of the updating frame region.

15. The apparatus of claim 12, wherein the instructions are further executable by the processor to cause the apparatus to:
reduce a clock rate of a display serial interface of the device based at least in part on the ratio of the number of lines of the updating frame region to the number of lines preceding the ending line of the updating frame region.

16. The apparatus of claim 11, wherein reducing the bus bandwidth vote reduces a pixel processing rate of the device in proportion to the static frame region of the plurality of frames that precedes the starting line of the updating frame region.

17. The apparatus of claim 16, wherein pixels of lines of the static frame region do not change from frame to frame.

18. The apparatus of claim 11, wherein one or more pixels of the lines of the updating frame region change from frame to frame.

19. A non-transitory computer-readable medium storing code for adaptive display data transfer rate by a device, the code comprising instructions executable by a processor to:
identify a plurality of frames for display on a panel of the device;
determine a starting line of an updating frame region of the plurality of frames in relation to a first pixel line of the panel;
determine an ending line of the updating frame region of the plurality of frames in relation to the first pixel line of the panel, wherein the panel comprises the updating frame region and a static frame region that precedes the starting line of the updating frame region, or is after the ending line of the updating frame region, or both, the updating frame region and the static frame region being configured for displaying content on the panel of the device;
reduce a bus bandwidth vote based at least in part on the starting line of the updating frame region, or the ending line of the updating frame region, or a number of lines of the updating frame region, or any combination thereof; and
transfer the lines of the updating frame region from a display processor unit to a panel memory at the reduced bus bandwidth.

20. The non-transitory computer-readable medium of claim 19, wherein the instructions to reduce the bus bandwidth vote are executable to:
reduce the bus bandwidth vote based at least in part on a ratio of the number of lines of the updating frame region to a number of lines preceding the ending line of the updating frame region.
